(19) United States
(12) Patent Application Publication
(10) Pub. No.: US 2024/0152919 A1
(43) Pub. Date: May 9, 2024

(54) SECURE ALTERNATE COMMUNICATION ROUTES

(71) Applicant: International Business Machines Corporation, Armonk, NY (US)

(72) Inventors: Shilpa SHETTY, Bangalore (IN); Jignesh K. KARIA, Thane (IN); Mukundan SUNDARARAJAN, Bangalore (IN); Pankaj Satyanarayan DAYAMA, Bangalore (IN); Neha SHAH, Kolkata (IN); Vishal AWAL, Mumbai (IN)

(21) Appl. No.: 18/052,453

(22) Filed: Nov. 3, 2022

(51) Int. Cl. G06Q 20/40; G06Q 20/38

(52) U.S. Cl. CPC G06Q 20/4014; G06Q 20/3825; G06Q 20/409

(57) ABSTRACT

Techniques are provided for generating secure, alternate communication routes. In one embodiment, the techniques involve receiving user consent and delivery data, wherein the delivery data includes information for contacting a device associated with a user, receiving an authentication failure indicator corresponding to a primary communication route to reach the user to authenticate an online transaction, initiating a scrubbing process to verify that the user consent indicates permission from a user to transfer an authentication credential via an alternate communication route, identifying a network state, generating the alternate communication route to the user based on the network state, the scrubbing process, and the delivery data, and transferring the authentication credential via the alternate communication route.

### BACKGROUND

The present invention relates to distributed ledger technologies, and more specifically, to using distributed ledger technologies to provide secure communication routes.

### SUMMARY

A method is provided according to one embodiment of the present disclosure. The method includes receiving user consent and delivery data, wherein the delivery data includes information for contacting a device associated with a user; receiving an authentication failure indicator corresponding to a primary communication route to reach the user to authenticate an online transaction; initiating a scrubbing process to verify that the user consent indicates permission from a user to transfer an authentication credential via an alternate communication route; identifying a network state; generating the alternate communication route to the user based on the network state, the scrubbing process, and the delivery data; and transferring the authentication credential via the alternate communication route.

A system is provided according to one embodiment of the present disclosure. The system includes a processor; and memory or storage comprising an algorithm or computer instructions, which when executed by the processor, performs an operation that includes: receiving user consent and delivery data, wherein the delivery data includes information for contacting a device associated with a user; receiving an authentication failure indicator corresponding to a primary communication route to reach the user to authenticate an online transaction; initiating a scrubbing process to verify that the user consent indicates permission from a user to transfer an authentication credential via an alternate communication route; identifying a network state; generating the alternate communication route to the user based on the network state, the scrubbing process, and the delivery data; and transferring the authentication credential via the alternate communication route.

A computer-readable storage medium having computer-readable program code embodied therewith, the computer-readable program code executable by one or more computer processors to perform an operation, is provided according to one embodiment of the present disclosure. The operation includes receiving user consent and delivery data, wherein the delivery data includes information for contacting a device associated with a user; receiving an authentication failure indicator corresponding to a primary communication route to reach the user to authenticate an online transaction; initiating a scrubbing process to verify that the user consent indicates permission from a user to transfer an authentication credential via an alternate communication route; identifying a network state; generating the alternate communication route to the user based on the network state, the scrubbing process, and the delivery data; and transferring the authentication credential via the alternate communication route.

### BRIEF DESCRIPTION OF THE DRAWINGS

FIG. 1 illustrates a computing environment, according to one embodiment.

FIG. 2 illustrates an alternate communication route generation environment, according to one embodiment.

FIG. 3 illustrates a flowchart of a method of transferring inputs to a smart contract that generates an alternate communication route, according to one embodiment.

FIG. 4 illustrates a flowchart of a method of generating an alternate communication route, according to one embodiment.

### DETAILED DESCRIPTION

Traditional telecom-enabled systems often use authentication systems, such as one-time password (OTP) systems to authenticate online transactions. Typically, the OTP system generates a 4-6 digit code when a user initiates an online transaction. The telecommunication service provider then delivers the code to the user via a short message service (SMS) message. The user can authenticate the online transaction by entering the code online within a given time limit. However, OTP systems cannot authenticate a transaction when the SMS message cannot be delivered to the user.

Embodiments of the present disclosure improve upon authentication systems by using distributed ledger technology to dynamically provide secure, alternate communication routes between a telecommunication service provider and a user based on underlying causes of incomplete SMS communications. In one embodiment, when an SMS message that includes an authentication credential cannot be delivered to a device of a user via a primary communication route, a smart contract dynamically generates alternate communication routes to deliver the authentication credential to the user.

One benefit of the disclosed embodiments is to enable robust authentication systems so that online transactions can be completed despite network outages, technological failures, or poor signal reception.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

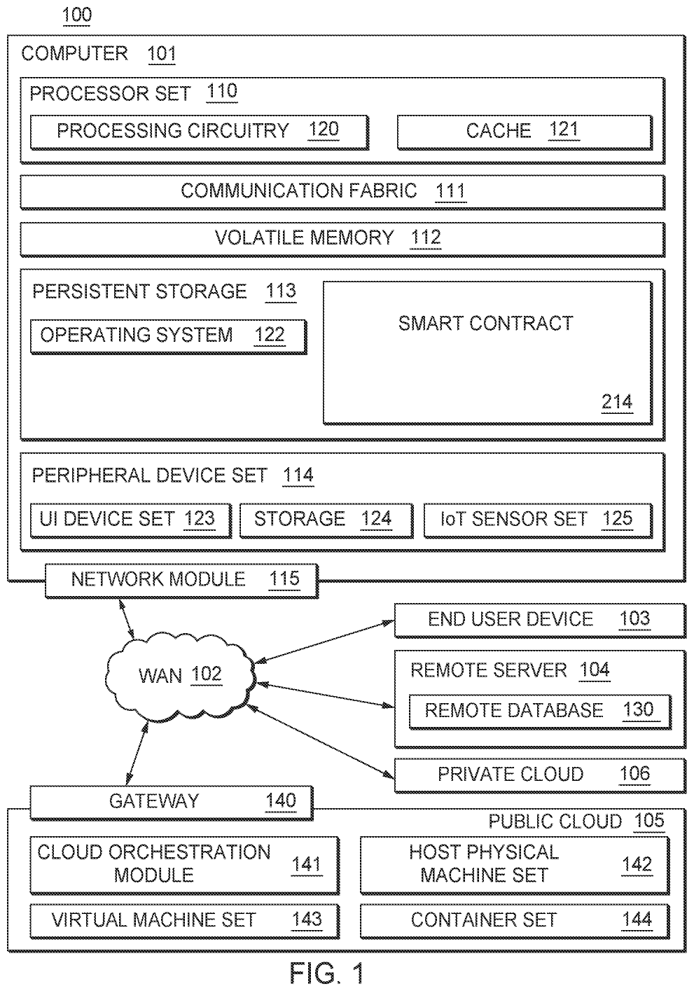

FIG. 1 illustrates a computing environment 100, according to one embodiment. Computing environment 100 contains an example of an environment for the execution of at least some of the computer code involved in performing the inventive methods, such as new smart contract 214 code. In addition to block 214, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 214, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 214 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 214 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

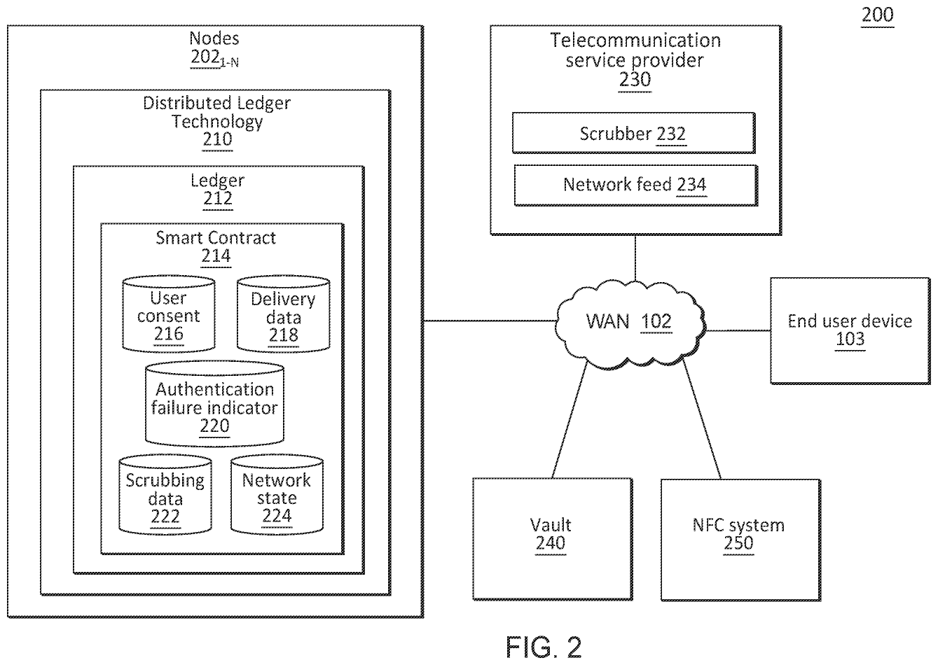

FIG. 2 illustrates an alternate communication route generation environment 200, according to one embodiment. In the illustrated environment, the alternate communication route generation environment 200 includes WAN 102, end user device 103, nodes 202_{1-N}, telecommunication service provider 230, vault 240, and NFC system 250.

The WAN 102 facilitates wireless communication between the end user device 103, nodes 202_{1-N}, telecommunication service provider (TSP) 230, vault 240, and NFC system 250. The end user device 103 can be a phone or other electronic device that can receive SMS messages, and can communicate using wireless protocols.

Each of the nodes 202_{1-N} include a computing environment (e.g., computing environment 100) that runs a distributed ledger technology (DLT) 210. In one embodiment, node 202₁ includes computer 101. In one embodiment, a DLT includes references to a distributed system that records and synchronizes transactions on ledgers stored on multiple nodes, such that each ledger includes an identical and immutable record of the transactions. Examples of DLTs include blockchains, directed acyclic graphs, hybrid data structures, and the like.

In one embodiment, the processor set 110 of computer 101 executes a smart contract 214 to perform the processes described herein. In the illustrated embodiment, a smart contract 214 is deployed to DLT 210 as a transaction on the ledger 212. In another embodiment, the smart contract 214 is not stored on the ledger 212. For example, the smart contract may be stored in a virtualized container in the memory or storage of a node, or on server communicatively coupled to the node.

In one embodiment, a smart contract includes references to software that automatically performs functions or operations of the code when predetermined conditions are met. The predetermined conditions can include any combination of satisfying input requirements specified in the smart contract 214, invocation of the smart contract 214 via a transaction on the DLT 210, and the like.

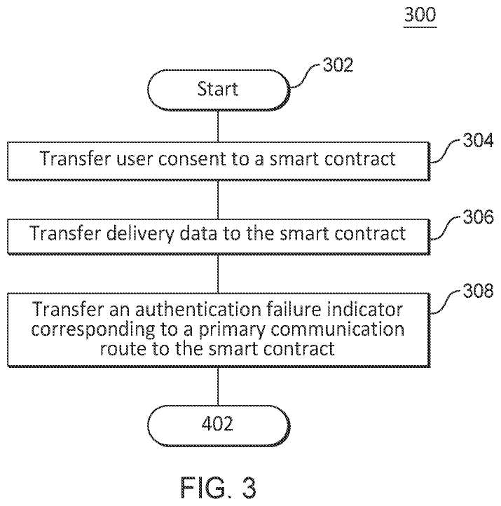

The TSP 230 generally provides cellular, internet, and other data communication services to the end user device 130. In the illustrated embodiment, the TSP 230 includes scrubber 232 and network feed 234. The scrubber 232 can compare a subset list of users to a superset list of users to identify information about users in the subset list, and transfer the results to the smart contract 214. The network feed 234 can continuously assess the state of networks used by the TSP 230, and feed the network state to the smart contract 214. These processes are described in further detail in FIG. 3.

In one embodiment, a user transfers user consent 216 and delivery data 218 to the smart contract 214. For example, a web user interface or a mobile app can allow the user to select an option (via a checkbox or a pulldown menu) to provide the user consent 216 to the smart contract 214. The web user interface or mobile app can allow the user to provide delivery data 218 (via text entry fields, checkboxes, or a pulldown menus) to the smart contract 214. The user consent 216 and delivery data 218 are described in further detail in FIG. 3.

Afterwards, when the user initiates an online transaction, an electronic commerce entity can transfer an authentication credential in an SMS message to the end user device 103 via the TSP 230. If the SMS message cannot be delivered to the end user device 103, then the TSP 230 can send an authentication failure indicator 220 to the smart contract 214.

The smart contract 214 can automatically execute when it receives the user consent 216, delivery data 218, and authentication failure indicator 220. In one embodiment, the smart contract 214 generates a communication route based on scrubbing data 222, a network state 224, and the deliver data 218. The smart contract 214 then transfers the authentication credential via the communication route. This process is described in greater detail in FIG. 3.

FIG. 3 illustrates a flowchart of a method 300 of transferring inputs to a smart contract 214 that generates an alternate communication route, according to one embodiment. The method 300 beings at block 302.

At block 304, a user transfers a user consent 216 to the smart contract 214. In one embodiment, the user consent 216 represents a permission to use an alternate communication route to deliver an authentication credential to the end user device 103.

The user can provide the user consent 216 to the smart contract 214 when the user signs up for a service from the TSP 230. However, the user can also provide the user consent 216 via a web user interface or a mobile app of the smart contract 214 at any time prior to an auto-execution of the smart contract 214. Generally, the user provides the user consent 216 to the smart contract 214 before the user initiates an online transaction.

When the user initiates the online transaction, an electronic commerce entity can use an authentication system to generate an authentication credential that can be entered by the user online to authenticate the transaction. The authentication system can use a primary communication route to transfer the authentication credential to the user. In one embodiment, the primary communication route comprises a cellular transmission from the TSP 230 to the end user device 103. For instance, the primary communication route can involve the TSP 230 sending an SMS message containing the authentication credential to the end user device 103 via a cellular signal.

The user consent 216 can include a permission for the smart contract 214 to send the authentication credential via an alternate communication route when the authentication credential cannot be delivered to the end user device 103 using the primary communication route. In one embodiment, the user consent 216 is added to a list stored in a mempool used by the smart contract 214.

At block 306, a user transfers delivery data 218 to the smart contract 214. The delivery data 218 can include at least one of: an alternate phone number or electronic contact information associated with the user; a website, IP address, or online access point of an online vault 240; an IP address or network access point of an NFC system 250; and the like.

The user can provide the delivery data 218 to the smart contract 214 when the user signs up for a service from the TSP 230. However, the user can also provide the delivery data 218 via a web user interface or a mobile app of the smart contract 214 at any time prior to the auto-execution of the smart contract 214. Generally, the user provides the delivery data 218 to the smart contract 214 before the user initiates an online transaction.

At block 308, the TSP 230 transfers an authentication failure indicator 220 corresponding to a primary communication route to the smart contract 214. In one embodiment, the TSP 230 sends the authentication failure indicator 220 to the smart contract 214 when the TSP 230 cannot deliver the authentication credential to the end user device 103 via the primary communication route. The authentication failure indicator 220 can be any data, data type, message, or the like, suitable to convey the failed delivery of the authentication credential to the end user device 103.

For example, the authentication failure indicator 220 may be the SMS message with the authentication credential that was sent to the end user device 103. In this example, the smart contract 214 can consider the transactional message to be an authentication failure indicator 220 since the message would otherwise have been sent to the end user device 103, but not to the smart contract 214.

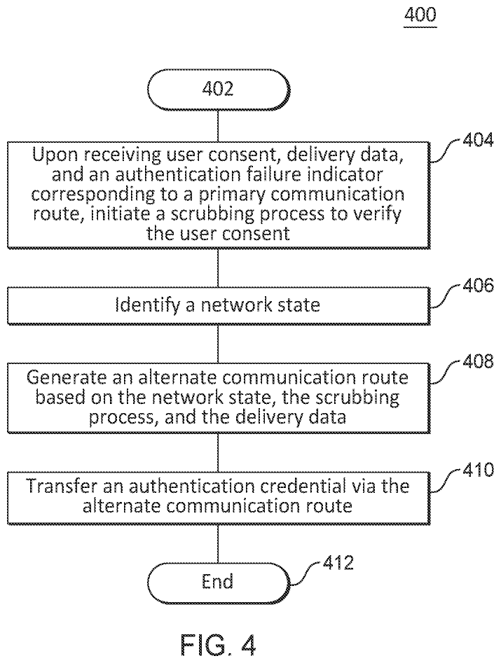

Having received the user consent 216, the delivery data 218, and authentication failure indicator 220 as inputs, the smart contract can begin an automatic execution of processes to generate an alternate communication route. These processes begin at block 402, and are explained in further detail in FIG. 4.

FIG. 4 illustrates a flowchart of a method 400 of generating an alternate communication route, according to one embodiment. The method 400 begins at block 402.

At block 404, upon receiving the user consent 216, delivery data 218, and the authentication failure indicator 220, the smart contract 214 initiates a scrubbing process to verify the user consent 216. In one embodiment, a scrubbing process references a process for verifying whether the user has given consent to the smart contract 214 to transfer the authentication credential via an alternate communication route.

The smart contract 214 can automatically execute when it receives the user consent 216, delivery data 218, and authentication failure indicator 220. In one embodiment, the smart contract 214 begins the automatic execution of the smart contract 214 by sending data, a message, a notification, or the like, to the TSP 230. Once the scrubbing process is initiated, the TSP 230 can compare a device identifier (e.g., phone number, MAC address, or the like) of the end user device 103 as identified from the user consent 216 to a list of customer devices in a database of the TSP 230. The database can include information about the consent status of each customer. When the TSP 230 finds a match between the device identifier and a device of a customer who has given consent, the TSP 230 transfers the verification of consent as scrubbing data 222 to the smart contract 214.

At block 406, the smart contract 214 identifies a network state 224. In one embodiment, a network state references at least one of: a present operability of a network of the TSP 230 in the vicinity of the last recorded area of the end user device 103 (“a network state of the TSP”), or a present operability of a local network connection as experienced by the end user device 103 (“a network state of the end user device”). As a non-limiting example, a network state may be “fully operational,” “partially operational,” or “not operational.”

In one embodiment, the TSP 230 determines a network state by evaluating the last recorded locations of multiple devices, which include end user device 103. The TSP 230 can receive message delivery errors and corresponding phone numbers of the devices from an SMS carrier. The TSP 230 can then determine the last recorded locations of each device using information from geographic information systems (GIS), such as communication tower pings, GPS data, and the like. The last recorded locations of the devices can be used to determine when devices in close proximity had concurrent delivery failures. Hence, the TSP 230 can infer a “not operational” network state for an area defined by the last recorded locations of the devices. Further, this inference can be strengthened using data on alarms reported by communication towers in the area, and data about calls made to a customer service center of the TSP 230. After determining the network state, the TSP 230 can provide this information to the smart contract 214 via a continuous or periodic network feed 234.

In one embodiment, when the network state of the TSP 230 is “fully operational,” the smart contract 214 can first request that the TSP 230 resend the authentication credential to the end user device 103. Afterwards, if another authentication failure indicator 220 is received for the end user device 103, then the smart contract 214 can determine that the received authentication failure indicator 220 is due to the network state of the end user device 103 being “not operational.” For example, the end user device 103 may have poor signal reception, or otherwise be in a location unreachable by the wireless transmissions of the TSP 230. In another embodiment, the smart contract 214 can make the above-described determination of the network state of the end user device 103 without first attempting to resend the authentication credential.

In one embodiment, when the network state of the TSP 230 is “partially operational” in the area of the end user device 103, then the smart contract 214 can request that the TSP 230 resend the authentication credential to the end user device 103. Afterwards, if another authentication failure indicator 220 is received for the end user device 103, the smart contract 214 can determine that the network state of the TSP 230 is “not operational.” When the network state of the TSP 230 or the network state of the end user device 103 is “not operational,” the method proceeds to block 408.

At block 408, the smart contract 214 generates an alternate communication route based on the network state 224, the scrubbing data 222, and the delivery data 218. As discussed above, the delivery data 218 can include at least one of: an alternate phone number or electronic contact information associated with the user; a website, IP address, or online access point of an online vault 240; an IP address or network access point of an NFC system 250; and the like.

After the user consent 216 has been verified via the scrubbing data 222, the smart contract 214 can use the network state 224 and delivery data 218 to generate an alternate communication route to deliver the authentication credential to the user or a destination device operated by the user.

In one embodiment, when the delivery data 218 includes an alternate phone number, the network state of the TSP 230 is “fully operational,” and the network state of the end user device 103 is “not operational,” the smart contract 214 can generate an alternate communication route that directs the authentication credential from the TSP 230 to a mobile service controller and terminating access point, and then to a device corresponding to the alternate number. For example, assume the end user device 103 that is associated with a first phone number and a second device that is associated with the alternate phone number are located in different areas of a building. If the end user device 103 has poor signal reception and cannot receive an SMS with the authentication credential, the smart contract 214 may generate an alternate communication route to direct the SMS from the TSP 230 to the second device.

In another embodiment, when the delivery data 218 includes a website, IP address, or online access point of an online vault 240, and the network state of the TSP 230 is “not operational,” the smart contract 214 can generate an alternate communication route that pushes the authentication credential to the vault 240 via the online access point. The user can then access the authentication credential from the vault 240 via the WAN 102 (e.g., on the internet).

In yet another embodiment, when the delivery data 218 includes an IP address or online access point of an NFC system 250, and the network state of the end user device 103 is “not operational,” the smart contract 214 can generate an alternate communication route that directs the authentication credential to the NFC system 250, and then to the end user device 103 or a second device. For example, assume the user initiates a transaction at an NFC-enabled ATM that verifies transactions using an OTP system. If the end user device 103 has poor signal reception and cannot receive an SMS with the authentication credential, the smart contract 214 may generate an alternate communication route that directs the authentication credential to the NFC system 250, and then to ATM or to the end user device 103 via the NFC system 250.

At block 412, the smart contract 214 transfers an authentication credential via the alternate communication route. The method ends at block 412.

While the foregoing is directed to embodiments of the present invention, other and further embodiments of the invention may be devised without departing from the basic scope thereof, and the scope thereof is determined by the claims that follow.

What is claimed is:

1. A method comprising:
receiving user consent and delivery data, wherein the delivery data includes information for contacting a device associated with a user;
receiving an authentication failure indicator corresponding to a primary communication route to reach the user to authenticate an online transaction;
initiating a scrubbing process to verify that the user consent indicates permission from a user to transfer an authentication credential via an alternate communication route;
identifying a network state;
generating the alternate communication route to the user based on the network state, the scrubbing process, and the delivery data; and
transferring the authentication credential via the alternate communication route.

2. The method of claim 1, wherein initiating the scrubbing process, identifying the network state, generating the alternate communication route, and transferring the authentication credential, are performed via a smart contract that automatically executes upon receiving the user consent, the delivery data, and the authentication failure.

3. The method of claim 1, wherein the delivery data comprises at least one of: (i) a phone number or electronic contact information of a device; (ii) a website, IP address, or online access point of an online vault; or (iii) an IP address or network access point of an NFC system, and wherein the authentication failure indicator comprises data, a data type, or a message that indicates a failed delivery of the authentication credential via the primary communication route.

4. The method of claim 1, wherein the primary communication route comprises a cellular transmission from a telecommunication service provider to an end user device, and wherein the cellular transmission includes an SMS message comprising the authentication credential.

5. The method of claim 1, wherein the scrubbing process verifies the user consent by comparing a device identifier from the user consent to a list of customer devices in a consent database of a telecommunication service provider.

6. The method of claim 1, wherein the network state indicates at least one of: a present operability of a network of a telecommunication service provider in the vicinity of a last recorded area of an end user device, or a present operability of a local network connection as experienced by the end user device.

7. The method of claim 1, wherein identifying the network state comprises:
evaluating last recorded locations of multiple devices using pings to a communication tower or GPS data; and
inferring a network state based on a proximity of concurrent delivery failures of the multiple devices, data on alarms reported by the communication tower, or data about calls made to a customer service center of a telecommunication service provider.

8. A system, comprising:
a processor; and
memory or storage comprising an algorithm or computer instructions, which when executed by the processor, performs an operation comprising:
receiving user consent and delivery data;
receiving user consent and delivery data, wherein the delivery data includes information for contacting a device associated with a user;
receiving an authentication failure indicator corresponding to a primary communication route to reach the user to authenticate an online transaction;
initiating a scrubbing process to verify that the user consent indicates permission from a user to transfer an authentication credential via an alternate communication route;
identifying a network state;
generating the alternate communication route to the user based on the network state, the scrubbing process, and the delivery data; and
transferring the authentication credential via the alternate communication route.

9. The system of claim 8, wherein initiating the scrubbing process, identifying the network state, generating the alternate communication route, and transferring the authentication credential, are performed via a smart contract that automatically executes upon receiving the user consent, the delivery data, and the authentication failure.

10. The system of claim 8, wherein the delivery data comprises at least one of: (i) a phone number or electronic contact information of a device; (ii) a website, IP address, or online access point of an online vault; or (iii) an IP address or network access point of an NFC system, and wherein the authentication failure indicator comprises data, a data type, or a message that indicates a failed delivery of the authentication credential via the primary communication route.

11. The system of claim 8, wherein the primary communication route comprises a cellular transmission from a telecommunication service provider to an end user device, and wherein the cellular transmission includes an SMS message comprising the authentication credential.

12. The system of claim 8, wherein the scrubbing process verifies the user consent by comparing a device identifier from the user consent to a list of customer devices in a consent database of a telecommunication service provider.

13. The system of claim 8, wherein the network state indicates at least one of: a present operability of a network of a telecommunication service provider in the vicinity of a last recorded area of an end user device, or a present operability of a local network connection as experienced by the end user device.

14. The system of claim 8, wherein identifying the network state comprises:
evaluating last recorded locations of multiple devices using pings to a communication tower or GPS data; and
inferring a network state based on a proximity of concurrent delivery failures of the multiple devices, data on alarms reported by the communication tower, or data about calls made to a customer service center of a telecommunication service provider.

15. A computer-readable storage medium having computer-readable program code embodied therewith, the computer-readable program code executable by one or more computer processors to perform an operation comprising:
receiving user consent and delivery data, wherein the delivery data includes information for contacting a device associated with a user;
receiving an authentication failure indicator corresponding to a primary communication route to reach the user to authenticate an online transaction;
initiating a scrubbing process to verify that the user consent indicates permission from a user to transfer an authentication credential via an alternate communication route;
identifying a network state;
generating the alternate communication route to the user based on the network state, the scrubbing process, and the delivery data; and
transferring the authentication credential via the alternate communication route.

16. The computer program product of claim 15, wherein initiating the scrubbing process, identifying the network state, generating the alternate communication route, and transferring the authentication credential, are performed via a smart contract that automatically executes upon receiving the user consent, the delivery data, and the authentication failure.

17. The computer program product of claim 15, wherein the delivery data comprises at least one of: (i) a phone number or electronic contact information of a device; (ii) a website, IP address, or online access point of an online vault; or (iii) an IP address or network access point of an NFC system, and wherein the authentication failure indicator comprises data, a data type, or a message that indicates a failed delivery of the authentication credential via the primary communication route.

18. The computer program product of claim 15, wherein the scrubbing process verifies the user consent by comparing a device identifier from the user consent to a list of customer devices in a consent database of a telecommunication service provider.

19. The computer program product of claim 15, wherein the network state indicates at least one of: a present operability of a network of a telecommunication service provider in the vicinity of a last recorded area of an end user device, or a present operability of a local network connection as experienced by the end user device.

20. The computer program product of claim 15, wherein identifying the network state comprises:
evaluating last recorded locations of multiple devices using pings to a communication tower or GPS data; and
inferring a network state based on a proximity of concurrent delivery failures of the multiple devices, data on alarms reported by the communication tower, or data about calls made to a customer service center of a telecommunication service provider.
